(19) United States
(12) Patent Application Publication
(10) Pub. No.: US 2019/0155697 A1
(43) Pub. Date: May 23, 2019

(54) DATA BACKUP METHOD AND TERMINAL

(71) Applicant: Huizhou TCL Mobile Communication Co., Ltd, Huizhou, Guangdong (CN)

(72) Inventors: Xin Li, Huizhou, Guangdong (CN); Yu Zheng, Huizhou, Guangdong (CN)

(21) Appl. No.: 16/313,886

(22) PCT Filed: May 17, 2017
(86) PCT No.: PCT/CN2017/084737

§ 371 Date: Dec. 28, 2018

(30) Foreign Application Priority Data
Jul. 1, 2016 (CN) 201610518924.X

(51) Int. Cl. G06F 11/14; H04W 76/10; H04W 4/80; G06F 9/54; H04L 29/06

(52) U.S. Cl. CPC G06F 11/1464; G06F 11/1456; H04W 76/10; G06F 11/1469; G06F 9/542; H04L 63/0428; H04W 4/80

(57) ABSTRACT

The present disclosure provides a data backup method and a terminal. The data backup method includes the following steps: detecting a data backup trigger event; responding the data backup trigger event and sending a setting information for defining a connection manner between a data source device and a data receiving device to the data receiving device; performing an attempt connection between the data source device and the data receiving device according to the connection manner; after the connection is successful, sending a data to be backed up to the data receiving device; or receiving a setting information for defining a connection manner between a data source device and a data receiving device; performing an attempt connection between the data source device and the data receiving device according to the connection manner; after the connection is successful, receiving a data to be backed up sent by the data source device.

### TECHNICAL FIELD

The present disclosure relates to the field of communication and display technologies, and in particular to a data backup method and a terminal.

### BACKGROUND

With a development of cities in a direction of information and the penetration of computer networks in national life, people are increasingly talking about touch screens. It is widely used in a wide variety of equipment due to its ease of use, ruggedness, fast response and space saving.

However, if a touch screen or display screen of a device is damaged, most of operation functions will not be used. In many cases, if components of the touch screen cannot be replaced in time, many important data in the device cannot be taken out, and cost of changing the screen is very high. In addition, there are many other situations where other users cannot back up data through normal screen input. For example, a device communication function is damaged, a specific hardware switch is damaged, and an internal circuit is faulty, etc., so that the data cannot be transferred, which brings inconvenience to users.

On the other hand, if simply judge the screen damage and start large-scale data transfer, there will be a problem of leaking data. Therefore, it is necessary to protect the data transfer process from a traceability of the data transfer process according to trustworthiness verification mechanisms even after the device has been damaged.

### SUMMARY

The present disclosure provides a data backup method and a terminal. After detecting a corresponding trigger event, a connection confirmation with a data receiver is automatically completed, thereby realizing emergency transmission and backup of data.

To solve the aforesaid technical problem, a technical solution adopted by the present disclosure provides a data backup terminal, including: a processor and a transceiver connected to the processor; wherein the processor is configured to: detect a data backup trigger event; transmit a setting information for defining a connection manner between a data source device and a data receiving device to the data receiving device through the transceiver in respond to the data backup trigger event; perform an attempt connection between the data source device and the data receiving device according to the connection manner; and send a data to be backed up to the data receiving device through the transceiver after the connection is successful.

To solve the aforesaid technical problem, a technical solution adopted by the present disclosure provides a data backup terminal, including: a processor and a transceiver connected to the processor; wherein the processor is configured to: receive a setting information for defining a connection manner between a data source device and a data receiving device by the transceiver; perform an attempt connection between the data source device and the data receiving device according to the connection manner; and receive a data to be backed up sent by the data source device by the transceiver after the connection is successful.

To solve the aforesaid technical problem, a technical solution adopted by the present disclosure provides a data backup method including the following steps: detecting a data backup trigger event; responding the data backup trigger event and sending a setting information for defining a connection manner between a data source device and a data receiving device to the data receiving device; performing an attempt connection between the data source device and the data receiving device according to the connection manner; after the connection is successful, sending a data to be backed up to the data receiving device; or receiving a setting information for defining a connection manner between a data source device and a data receiving device; performing an attempt connection between the data source device and the data receiving device according to the connection manner; after the connection is successful, receiving a data to be backed up sent by the data source device.

The present disclosure provides a method and a terminal for data backup. After detecting the corresponding trigger event, the connection confirmation with the data receiver is automatically completed, thereby realizing emergency transmission and backup of data. In particular, in a preferred embodiment, the present disclosure enables automatic transmission and backup of data automatically when a user is unable to input backup instructions and settings through a normal user interface.

### BRIEF DESCRIPTION OF THE DRAWINGS

FIG. 1 is a flow chart of a data transmitting terminal of an embodiment of a data backup method according to the present disclosure;

FIG. 2 is a flow chart of a data receiving terminal of an embodiment of a data backup method according to the present disclosure;

FIG. 3 is a schematic structural diagram of an embodiment of a data backup terminal according to the present disclosure;

FIG. 4 is a schematic structural diagram of another embodiment of a data backup terminal according to the present disclosure;

FIG. 5 is a schematic structural diagram of an embodiment of a data backup device according to the present disclosure;

FIG. 6 is a schematic structural diagram of another embodiment of a data backup device according to the present disclosure;

FIG. 7 is a schematic structural diagram of still another embodiment of a data backup device according to the present disclosure;

FIG. 8 is a schematic structural diagram of an embodiment of a storage device with memory function of the present disclosure.

### DETAILED DESCRIPTION

Hereinbelow, technical solutions of the embodiments of the present disclosure will be described clearly and fully with reference to the attached drawings illustrating the embodiments of the present disclosure. Obviously, the embodiments described herein are only a part of but not all of the embodiments of the present disclosure. All other embodiments that can be obtained by those of ordinary skill in the art from the embodiments of the present disclosure without making creative efforts shall fall within the scope of the present disclosure.

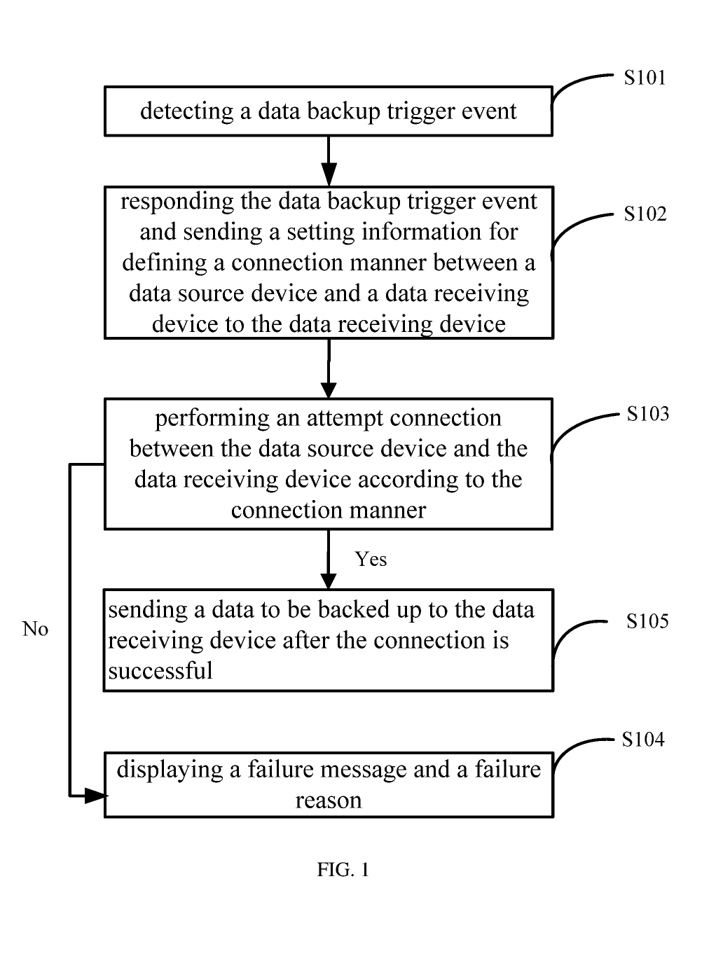

Referring to FIG. 1, FIG. 1 is a flow chart of a data transmitting terminal of an embodiment of a data backup method according to the present disclosure. As shown in FIG. 1, the data backup method may include the following steps:

Step S101: detecting a data backup trigger event.

In a preferred embodiment, detecting the data backup trigger event by detecting whether an external message received by a data source device contains a data backup instruction or detecting whether the data source device itself has an internal trigger event. When there is a data backup instruction in the external message or the internal trigger event exists in the data source device itself, it is regarded as detecting the data backup trigger event, and the data backup instruction is started.

The external message received by the data source device may include, but is not limited to, a short message, a multimedia message, an IP-based message, a third-party service information based on the OTT service, a Bluetooth-based peer-to-peer information, and a point-to-point information based on the USB port.

The internal trigger event of the data source device itself may include: damage to a display screen or a touch screen, lack of human-computer interaction during a predetermined time, damage of a communication function, or triggering of a specific hardware switching device.

In the above two manners, a data backup process can be triggered by receiving the external message or the device automatically detecting the internal trigger event at the situation where the user cannot input the data backup instruction or a setting information through a normal user interface (for example, the touch screen).

Step S102: responding the data backup trigger event and sending a setting information for defining a connection manner between a data source device and a data receiving device to the data receiving device.

In a preferred embodiment, after the data source device detects the data backup trigger event, the data source device at least partially encrypts the setting information for defining the connection manner between the data source device and the data receiving device according to a predefined encryption algorithm or key to generate a connection information including a verification information, and sends a encrypted data to the data receiving device.

The setting information is an information previously set in the data source device for defining the connection manner between the data source device and the data receiving device. It may be a setting information of any one or both of the data source device and the data receiving device. Through the setting information above, one of the data source device and the data receiving device can search for the other of the data source device and the data receiving device and further attempt to establish a connection between the data source device and the data receiving device. For example, the setting information may include a following information of at least one of the data source device and the data receiving device: one or a combination of WIFI hotspot name and channel number, Bluetooth device name, IP address and IP port number, URL address and URL port number, and verification account information.

In a preferred embodiment, the encrypted data has two alternative transmission methods, one is loading the encrypted data as content into a specific message, and transmitting the specific message to a predefined address. The predefined address varies according to the specific implementation manner, and the present disclosure is not limited. For example, a communication number (for example, a mobile phone number), a mailbox address, or other addresses of the data receiving device can be preset in the data source device. Then, the data source device can send the foregoing specific message to the above address in the form of a short message, a multimedia message, or an email, so that the data source device can receive the above information.

Alternatively, the encrypted data can be encoded into a two-dimensional code, and the two-dimensional code can be displayed on the display screen of the data source device when the display is working normally.

Step S103: performing an attempt connection between the data source device and the data receiving device according to the connection manner.

In a preferred embodiment, after the specific message is sent or after the two-dimensional code is displayed, the data source device may wait or attempt to connect with the data receiving device according to the connection manner.

The setting information may be a setting information of a related communication device or an interface of the data receiving device. At this time, the data receiving device can reset the communication device or the interface according to the setting information. For example, the data receiving device can set its WIFI SSID to a specific character string according to the connection manner of the setting information and wait on a specific WIFI channel.

In a preferred embodiment, when the data receiving device receives the encrypted data in the form of receiving the specific message or scanning the two-dimensional code, it can restore the setting information by a specific decryption algorithm or key. And further, the data receiving device can set its WIFI SSID to the specific string, waiting to be ready to accept a WIFI direct access on the specific WIFI channel. When the data source device successfully searches for a WIFI access device that meets the connection manner in the vicinity, it can be confirmed that the WIFI access device is an authorized target data receiving device, and then attempts to connect to the WIFI access device.

In other embodiments, the setting information may be a setting information of an associated communication device or an interface of the data source device. At this time, the data receiving device may not need to reset its own communication device or interface, and only need to search for the data source device according to the setting information and try to establish a connection.

Step S104: displaying a failure message and a failure reason when the connection is unsuccessful.

In a preferred embodiment, when the data source device cannot successfully establish a connection with the data receiving device, the failure message and the failure reason may be displayed on the data source device screen, or the failure message can be sent to a predefined address to end the backup.

Step S105: sending a data to be backed up to the data receiving device after the connection is successful.

In a preferred embodiment, after the data source device and the data receiving device are successfully connected, the data source device may pack the data to be backed up according to a directory order of a specific level, send the data to be backed up to the data receiving device by means of serial transmission, and end the data backup process after the transmission is completed.

A packetization mode of the data to be backed up and a data transmission process can be different according to a data size and a communication bearer mode in the specific implementation, and the present disclosure is not forcibly limited.

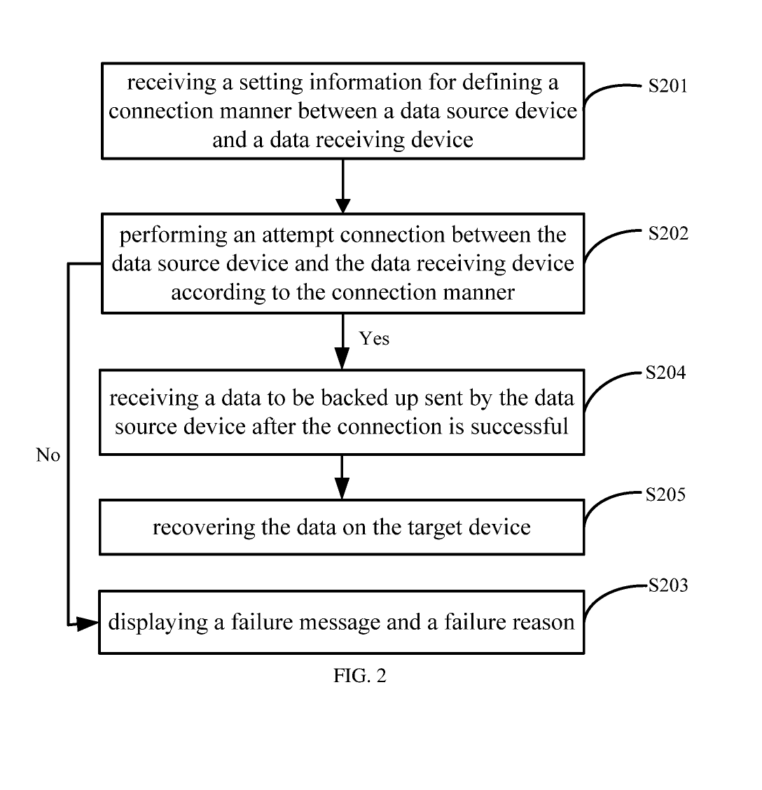

Referring to FIG. 2, FIG. 2 is a flow chart of a data receiving terminal of an embodiment of a data backup method according to the present disclosure. As shown in FIG. 2, the data backup method may include the following steps:

Step S201: receiving a setting information for defining a connection manner between a data source device and a data receiving device.

In a preferred embodiment, when the data source device detects a data backup trigger event, the data source device may turn on a data backup process, at least partially encrypt a setting information for defining a connection manner between the data source device and the data receiving device according to a predefined encryption algorithm or key to generate a connection information including a verification information, and send a encrypted data to the data receiving device, so that the data receive device may receive the encrypted data.

The setting information received by the data receiving device may include the following information of at least one of the data source device and the data receiving device: one or a combination of WIFI hotspot name and channel number, Bluetooth device name, IP address and IP port number, URL address and URL port number, and verification account information.

There may be two optional receiving manners for the data receiving device to receive the encrypted data. That is, receiving a specific message or scanning a two-dimensional code, and parsing and restoring the encrypted data through a specific decryption algorithm or key.

Step S202: performing an attempt connection between the data source device and the data receiving device according to the connection manner.

In a preferred embodiment, after receiving the specific message or scanning the two-dimensional code, the data receiving device may wait or attempt to connect with the data source device according to a parsed connection information.

The setting information may be a setting information of a related communication device or an interface of the data receiving device. At this time, the data receiving device can reset the communication device or the interface according to the setting information. For example, the data receiving device can set its WIFI SSID to a specific character string according to the connection manner of the setting information and wait on a specific WIFI channel.

In a preferred embodiment, when the data receiving device receives the encrypted data in the form of receiving the specific message or scanning a two-dimensional code, it can restore the setting information by a specific decryption algorithm or key. And further, the data receiving device can set its own WIFI SSID to the specific string, waiting to be ready to accept a WIFI direct access on the specific WIFI channel. When the data source device successfully searches for a WIFI access device that meets the connection manner in the vicinity, it can be confirmed that the WIFI access device is an authorized target data receiving device, and then attempts to connect to the WIFI access device.

In other embodiments, the setting information may be a setting information of an associated communication device or an interface of the data source device. At this time, the data receiving device may not need to reset its own communication device or interface, and only need to search for the data source device according to the setting information and try to establish a connection.

Step S203: displaying a failure message and a failure reason when the connection is unsuccessful.

In a preferred embodiment, when the data source device cannot successfully establish a connection with the data receiving device, the failure message and the failure reason may be displayed on the data source device screen, or the failure message can be sent to a predefined address to end the backup.

Step S204: receiving a data to be backed up sent by the data source device after the connection is successful.

In a preferred embodiment, after the data receiving device acquires the data to be backed up sent by the data source device, if the data receiving device is a target device for data recovery, the data may be backed up locally to the data receiving device to complete the transmission.

Step S205: replying the data on the target device.

In a preferred embodiment, after the data receiving device acquires the data to be backed up sent by the data source device, if the data receiving device is not the target device for data recovery, the data receiving device may transfer the data to the target device and reply, and end the data backup process. The specific implementation link may be different according to the relationship between the data receiving device and the target device and the connection manner, and the present disclosure is not mandatory.

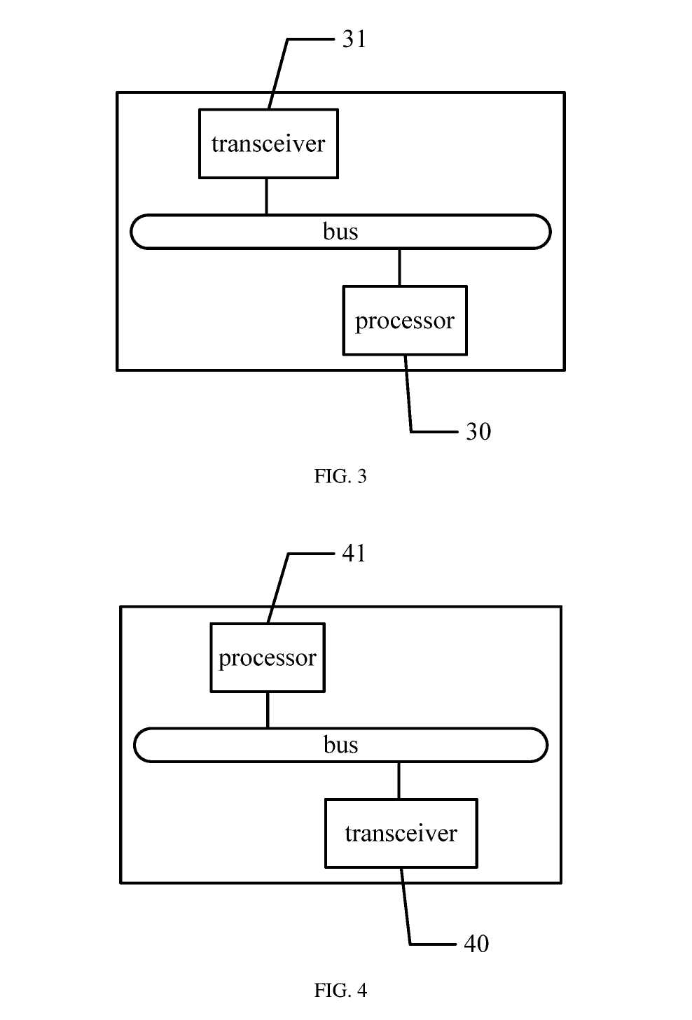

Please refer to FIG. 3. FIG. 3 is a schematic structural diagram of an embodiment of a data backup terminal according to the present disclosure. The terminal provided by the embodiment of the present disclosure may be an electronic device that can be used in the field of wireless communication, such as a smart phone or a tablet computer. In this embodiment, the terminal may include a processor 30 and a transceiver 31.

The processor 30 can be configured to detect a data backup trigger event, specifically, to detect whether an external message received by a data source device includes a data backup instruction, or to detect whether the data source device itself has an internal trigger event. When there is a data backup instruction in the external message or the internal trigger event exists in the data source device itself, the data backup trigger event may be deemed to be detected. Wherein, the internal trigger event may include damage to a display screen or a touch screen, lack of human-computer interaction during predetermined times, damage to a communication function, or triggering of a particular hardware switching device.

The processor 30 can be further configured to respond the data backup trigger event and send a setting information for defining a connection manner between the data source device and a data receiving device to the data receiving device through the transceiver 31. Specifically, the setting information may be at least partially encrypted according to a predefined encryption algorithm or key, and an encrypted data may be sent to the data receiving device. The setting information may include the following information of at least one of the data source device and the data receiving device: one or a combination of WIFI hotspot name and channel number, Bluetooth device name, IP address and IP port number, URL address and URL port number, and verification account information.

In other embodiments, the setting information can also be loaded as a content into a specific message, and the specific message can be sent to a predefined address, or the setting information can be encoded into a two-dimensional code and displayer on the display screen of the data source device.

The processor 30 can be further configured to make an attempted connection between the data source device and the data receiving device according to the connection manner. After the connection is successful, the processor 30 may be configured to transmit the data to be backed up to the data receiving device through the transceiver 31.

Module terminals of the above-mentioned devices can respectively perform the corresponding steps in the foregoing method embodiments, and therefore, the modules are not described herein. For details, refer to the description of the corresponding steps.

Please refer to FIG. 4. FIG. 4 is a schematic structural diagram of another embodiment of a data backup terminal according to the present disclosure. The terminal provided by the embodiment of the present disclosure may be an electronic device that can be used in the field of wireless communication, such as a smart phone or a tablet computer. In this embodiment, the terminal may include a processor 40 and a transceiver 41.

The processor 40 can be configured to receive a setting information for defining a connection manner between a data source device and a data receiving device by the transceiver 41, wherein the setting information may include the following information of at least one of the data source device and the data receiving device: one or a combination of WIFI hotspot name and channel number, Bluetooth device name, IP address and IP port number, URL address and URL port number, or verification account information.

The processor 40 may be is further configured to perform an attempt connection between the data source device and the data receiving device according to the connection manner. Specifically, the data receiving device may perform a corresponding setting on the data receiving device according to the setting information, so that the data source device can search for the data receiving device according to the setting information and attempt to establish a connection; or search for the data source device according to the setting information and attempt to establish a connection.

After the connection is successful, the processor 40 can be configured to receive a data to be backed up sent by the data source device through the transceiver 41, which specifically may include decrypting a received data according to a predefined encryption algorithm or key, thereby obtaining the setting information.

Module terminals of the above-mentioned devices can respectively perform the corresponding steps in the foregoing method embodiments, and therefore, the modules are not described herein. For details, refer to the description of the corresponding steps.

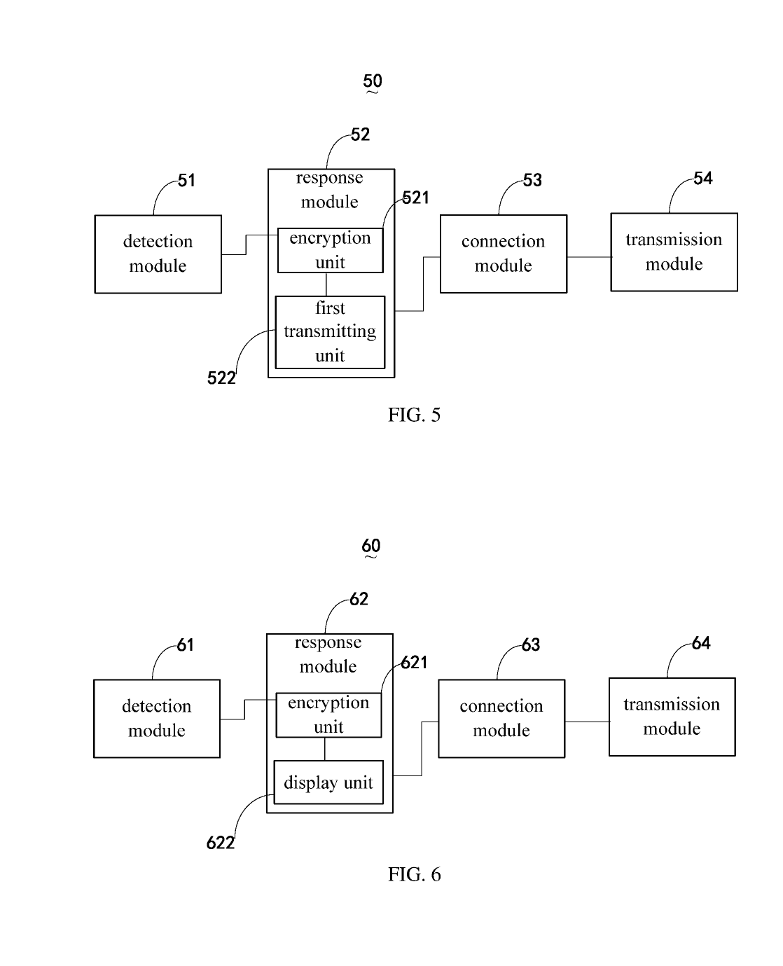

Please refer to FIG. 5. FIG. 5 is a schematic structural diagram of an embodiment of a data backup device according to the present disclosure. In this embodiment, the data backup device 50 may include a detection module 51, a response module 52, a connection module 53, and a transmission module 54.

The detection module 51 can be configured to detect a data backup trigger event, which may specifically include: detecting whether the external message received by a data source device includes a data backup instruction or detecting whether the data source device itself has an internal trigger event. If there is a data backup instruction in the external message or the internal trigger event exists in the data source device itself, the data backup trigger event may be deemed to be detected. The internal triggering event may include at least one of a damage of a display screen or a touch screen, lack of human-computer interaction during a predetermined time, damage of a communication function, or triggering of a specific hardware switching device.

The response module 52 can be configured to send a setting information for defining a connection manner between the data source device and the data receiving device to the data receiving device in response to the data backup trigger event, and may further include an encryption unit 521 and a first transmitting unit 522.

The encryption unit 521 can be configured to perform encryption on at least partial setting information according to a predefined encryption algorithm or key.

The first transmitting unit 522 can be configured to send the encrypted data to the data receiving device. The setting information may include the following information of at least one of the data source device and the data receiving device: one or a combination of WIFI hotspot name and channel number, Bluetooth device name, IP address and IP port number, URL address and URL port number, and verification account information.

The connection module 53 may be configured to make an attempt connection between the data source device and the data receiving device according to the connection manner.

The transmission module 54 may be configured to send the data to be backed up to the data receiving device after the connection is successful.

The data backup device 50 can perform the steps performed by the terminal in the above method. For related content, please refer to the detailed description in the above method, which will not be described here.

Please refer to FIG. 6. FIG. 6 is a schematic structural diagram of another embodiment of a data backup device according to the present disclosure. The difference from the above embodiment is that a response module 62 in this embodiment further may include a display unit 622 for encoding the encrypted data into a two-dimensional code. The two-dimensional code can be displayed on the display of the data source device when the display is working properly.

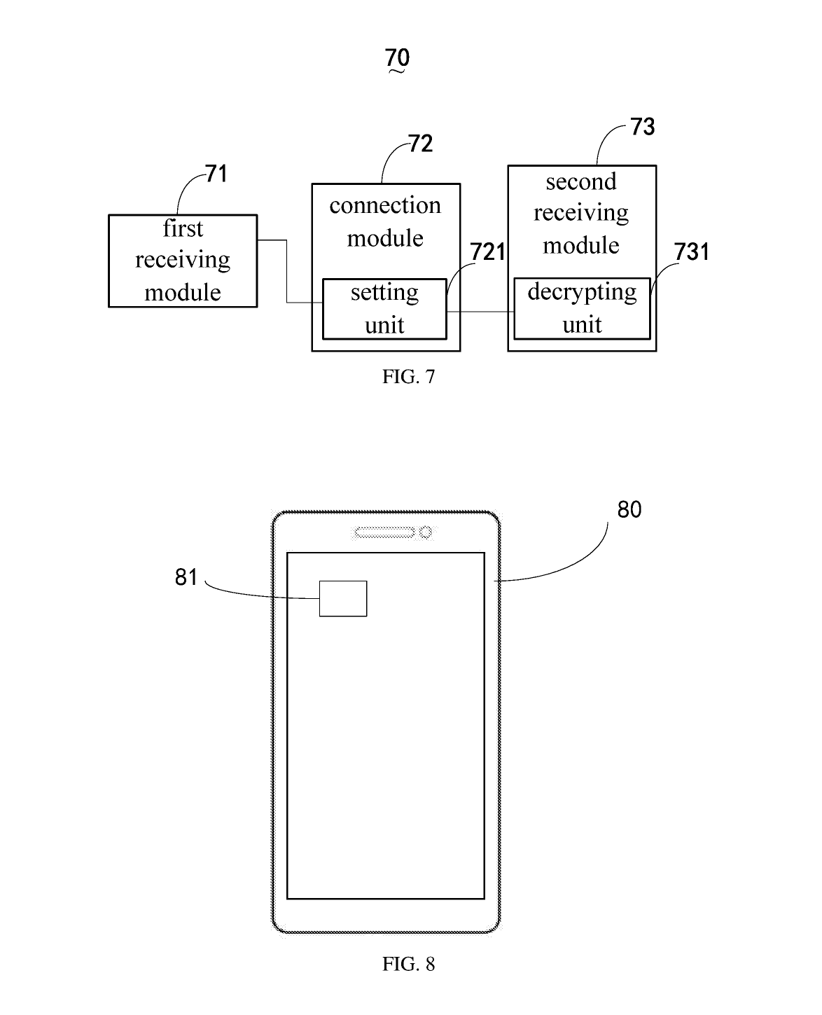

Please refer to FIG. 7. FIG. 7 is a schematic structural diagram of still another embodiment of a data backup device according to the present disclosure. In this embodiment, the data backup device 70 may include a first receiving module 71, a connection module 72, and a second receiving module 73.

The first receiving module 71 can be configured to receive a setting information for defining a connection manner between a data source device and a data receiving device. The setting information may include the following information of at least one of the data source device and the data receiving device: one or a combination of WIFI hotspot name and channel number, Bluetooth device name, IP address and IP port number, URL address and URL port number, or verification account information.

The connection module 72 may be configured to make an attempt connection between the data source device and the data receiving device according to a connection mode. The connection module 72 may further include a setting unit 721, which may be configured to perform a corresponding setting on the data receiving device according to the setting information, so that the data source device can search for the data receiving device according to the setting information and attempt to establish a connection, or, search for the data source device based on the setting information and try to establish a connection.

The second receiving module 73 can be configured to receive a data to be backed up sent by the data source device after the connection is successful. The second receiving module 73 may further include a decrypting unit 731, which may be configured to decrypt a received data according to a predefined encryption algorithm or key, thereby obtaining the setting information.

The device 70 can perform the steps performed by the terminal in the above method. For related content, please refer to the detailed description in the above method, which will not be described here.

Please refer to FIG. 8. FIG. 8 is a schematic structural diagram of an embodiment of a storage device with memory function of the present disclosure. The storage device 80 may be configured to store a program file 81 capable of implementing all of the above methods. The program file 81 may be stored in a storage device 80 in the form of a software product, may include a plurality of instructions for causing a computer device (can be a personal computer, server, or network device, etc.) or processor to perform all or part of the steps of the methods of various embodiments of the present disclosure. The foregoing storage device 80 may include: a medium that can store program codes, such as a USB, a mobile hard disk, a read-only memory (ROM), a random-access memory (RAM), a hard disk, or a disk, or a terminal device such as a computer, a server, a mobile phone, or a tablet.

In summary, it will be readily understood by those skilled in the art that the present disclosure provides a data backup method and terminal, which can automatically complete the connection confirmation with the data receiver after detecting a corresponding trigger time, thereby implementing emergency transmission and backup of data. In particular, in a preferred embodiment, the present disclosure enables automatic transmission and backup of data automatically when a user is unable to input backup instructions and settings through a normal user interface.

The above description is only the embodiments of the present disclosure, and thus does not limit the scope of the patent of the present disclosure. The equivalent structure or equivalent process transformations made by the present specification and the drawings are directly or indirectly applied to other related technical fields are included in the scope of patent protection of the present disclosure.

1. A data backup terminal, comprising:
a processor and a transceiver connected to the processor; wherein the processor is configured to:
detect a data backup trigger event;
transmit a setting information for defining a connection manner between a data source device and a data receiving device to the data receiving device through the transceiver in respond to the data backup trigger event;
perform an attempt connection between the data source device and the data receiving device according to the connection manner; and
send a data to be backed up to the data receiving device through the transceiver after the connection is successful.

2. The terminal according to claim 1, wherein
the processor is configured to detect whether an external message received by the data source device comprises a data backup instruction, or detect whether the data source device itself has an internal trigger event;
when the external message has the data backup instruction or the data source device itself has the internal trigger event, the data backup trigger event is deemed to be detected.

3. The terminal according to claim 2, wherein
the internal trigger event comprises damage to a display screen or a touch screen, lack of human-computer interaction during a predetermined time, damage to a communication function, or triggering of a particular hardware switching device.

4. The terminal according to claim 1, wherein
the processor is configured to at least partially encrypt the setting information according to a predefined encryption algorithm or key and transmit an encrypted data to the data receiving device through the transceiver.

5. The terminal according to claim 1, wherein
the setting information comprises the following information of at least one of the data source device and the data receiving device: one or a combination of WIFI hotspot name and channel number, Bluetooth device name, IP address and IP port number, URL address and URL port number, and verification account information.

6. The terminal according to claim 1, wherein
the processor is configured to load the setting information as content into a specific message and send the specific message to a predefined address through the transceiver, or encode the setting information into a two-dimensional code to be displayed on a display screen of the data source device.

7. A data backup terminal, comprising:
a processor and a transceiver connected to the processor; wherein the processor is configured to:
receive a setting information for defining a connection manner between a data source device and a data receiving device by the transceiver;
perform an attempt connection between the data source device and the data receiving device according to the connection manner; and
receive a data to be backed up sent by the data source device by the transceiver after the connection is successful.

8. The terminal according to claim 7, wherein
the processor is configured to perform a corresponding setting on the data receiving device according to the setting information, so that the data source device search for the data receiving device according to the setting information and try to establish a connection with the data receiving device;
alternatively, the processor is configured to search the data source device according to the setting information and attempt to establish a connection.

9. The terminal according to claim 7, wherein
the setting information comprises the following information of at least one of the data source device and the data receiving device: one or a combination of WIFI hotspot name and channel number, Bluetooth device name, IP address and IP port number, URL address and URL port number, or verification account information.

10. The terminal according to claim 7, wherein
the processor is configured to decrypt a data received by the transceiver according to a predefined encryption algorithm or key, thereby to obtain the setting information.

11. A data backup method comprising the following steps:
detecting a data backup trigger event;
responding the data backup trigger event and sending a setting information for defining a connection manner between a data source device and a data receiving device to the data receiving device;
performing an attempt connection between the data source device and the data receiving device according to the connection manner;
after the connection is successful, sending a data to be backed up to the data receiving device;
or receiving a setting information for defining a connection manner between a data source device and a data receiving device;
performing an attempt connection between the data source device and the data receiving device according to the connection manner;
after the connection is successful, receiving a data to be backed up sent by the data source device.

12. The method according to claim 11, wherein
detecting a data backup trigger event comprises:
detecting whether an external message received by the data source device comprises a data backup instruction, or detecting whether the data source device itself has an internal trigger event;
when the external message has the data backup instruction or the data source device itself has the internal trigger event, the data backup trigger event is deemed to be detected.

13. The method according to claim 12, wherein
the internal trigger event comprises damage to a display screen or a touch screen, lack of human-computer interaction during a predetermined time, damage to a communication function, or triggering of a particular hardware switching device.

14. The method according to claim 11, wherein
responding the data backup trigger event and sending a setting information for defining a connection manner between a data source device and a data receiving device to the data receiving device comprises:
at least partially encrypting the setting information according to a predefined encryption algorithm or key and transmitting an encrypted data to the data receiving device through the transceiver.

15. The method according to claim 11, wherein
the setting information comprises following information of at least one of the data source device and the data receiving device: one or a combination of WIFI hotspot name and channel number, Bluetooth device name, IP address and IP port number, URL address and URL port number, and verification account information.

16. The method according to claim 11, wherein
responding the data backup trigger event and sending a setting information for defining a connection manner between a data source device and a data receiving device to the data receiving device comprises:
loading the setting information as content into a specific message and sending the specific message to a predefined address through the transceiver, or encoding the setting information into a two-dimensional code to be displayed on a display screen of the data source device.

17. The method according to claim 11, wherein
receiving a setting information for defining a connection manner between a data source device and a data receiving device comprises:
decrypting a data received by the transceiver according to a predefined encryption algorithm or key, thereby obtain the setting information.

18. The method according to claim 11, wherein
performing an attempt connection between the data source device and the data receiving device according to the connection manner comprises:
performing a corresponding setting on the data receiving device according to the setting information, so that the data source device search for the data receiving device according to the setting information and try to establish a connection with the data receiving device;
alternatively, searching the data source device according to the setting information and attempt to establish a connection.
